(19) United States
(12) Patent Application Publication
(10) Pub. No.: US 2009/0202102 A1
(43) Pub. Date: Aug. 13, 2009

(54) METHOD AND SYSTEM FOR ACQUISITION AND DISPLAY OF IMAGES

(76) Inventors: Hermelo Miranda, Key Largo, FL (US); Telmo Sampaio, Miami, FL (US)

Correspondence Address: HOLLAND & HART, LLP, P.O BOX 8749, DENVER, CO, 80201, US

(21) Appl. No.: 12/059,841

(22) Filed: Mar. 31, 2008

Related U.S. Application Data
(60) Provisional application No. 61/065,036, filed on Feb. 8, 2008.

(51) Int. Cl. G06K 9/00

(52) U.S. Cl. 382/100

(57) ABSTRACT

A system and method for acquiring images and linking the images to positions is provided. In particular, images are taken using one or more cameras and identified with a particular time stamp. A position locating unit located close to the camera takes position determinations that are similarly time stamped with a clock that is synchronized with image time stamp clock. A processor calculates the position of the camera or unit carrying the camera at the time the image was shot based on the closest available positioning determination information and the velocity, or speed and direction, of the unit. The images may be linked as part of a series of images or linked based on stringing or vectoring the images associated with travel directions, such as, a particular block of residential images in a city or the like. The images are displayed individually for a static, 360 degree, panoramic view, or via a video or near video simulation to simulate driving conditions. The images, being associated with actual locations, allows for visual mapping and route information to be determined.

### CLAIM OF PRIORITY UNDER 35 U.S.C. §119

The present Application for Patent claims priority to Provisional Application No. 61/065,036 entitled “Method and System for Acquisition of Images” filed Feb. 8, 2008, which is hereby expressly incorporated by reference herein.

### CLAIM OF PRIORITY UNDER 35 U.S.C. §120

None.

### REFERENCE TO-CO-PENDING APPLICATIONS FOR PATENT

None.

### BACKGROUND

1. Field

The technology of the present application relates generally to acquisition of images, and more specifically to methods and systems to collect and process data to provide virtual drive-by systems and geospatial search applications to enable digital imagery.

2. Background

Panoramic photography and coding the panoramic photography to provide geo-coded locations, such as landmark site visuals, street address visuals, or the like has been in existence for some time. However, existing systems typically have numerous drawbacks and limitations.

One such limitation is that current technology is usually relatively slow, cumbersome, and limiting in its application. With the increase in digital photography, mapping technologies, and imaging, both aerial and satellite, these deficiencies may inhibit implementation of available information.

Conventional data collection systems to provide imagery commonly use the communication between a satellite positioning system (“SPS”) unit and a panoramic camera or set of cameras in a way that every time the SPS unit receives data from the SPS system, the camera or cameras are triggered to take a picture. These system usually are not very efficient based, in part, on the fact that the satellite in the SPS system sends out positioning data periodically. Even at a short interval of about one second, a camera or cameras obtaining imagery at thirty mph leaves approximately a thirty foot gap between snapshots or images. This results in choppy, incomplete, and generally less than satisfactory imaging of a particular location.

Another typical deficiency of conventional technology relates to the camera orientation during imaging. For example, when traveling on an incline, the image produced by conventional systems results in an image that is inclined relative to the user. This provides a difficult or distorted image to the end user.

Moreover, existing data processing systems for street level panoramic photos usually read the pictures taken by a data collection system and save the picture with a pointer, such as, for example, latitude and longitude data, to a database with the exact data collected with the data collection system. Because the data acquisition typically is tied to a SPS unit, each image obtained by the camera can be matched to a precise latitude and longitude. Thus, when requesting imagery, the requested imagery is matched to the nearest pointer, again typically latitude and longitude pairs, and displays the closest imagery for the requested imagery. The “closest” imagery may be determined in any of a number of conventional methods, such as, calculating an actual travel vector and locating the closest image along the vector, using a least mean square method to identify the closest latitude and longitude, etc. This calculation is necessary to show the picture on a real street when looking at it from a street map, usually resulting in a very inefficient process.

Current virtual drive-by imagery systems usually require user interaction to move from one picture to the next along a street, or allow the user to drive (or virtual drive) in such a form as to move over areas where a street does not exist. Further, existing virtual drive-by systems usually do not use a full spherical image during navigation, or require the end user to install a full blown application on their computers. This process is time consuming and not very efficient for a the user. Moreover, the user is limited typically to where he or she can physically be present. Thus, while instructive of actual conditions, using presently available imagery systems, a user usually must be physically present at a location to view the actual surroundings of a given neighborhood, site, or the like.

Conventional systems also typically are limited in its ability to allow location based searching for imagery because the imagery is limited to a pointer, which is often a latitude and longitude pair.

These and other issues associated with conventional imagery systems limit the application of available imagery and technology for broad based application.

### SUMMARY

The applicants have invented a method and system for the acquisition of geo-coded 360-degree, images. In one aspect, the invention provides an efficient and faster rate to collect data. For example, in one aspect there is no link between the GPS unit and camera units together to trigger a picture. A device, such as an inclinometer, can be utilized to detect the incline angle at which pictures are taken so it can later tilt the image to correct the inclination.

In one aspect of the technology, a method can be achieved by running three systems concurrently. One system may control the camera by starting the camera in video mode and collecting up to six pictures per second, without waiting for a signal from the GPS unit. Each picture is stamped with the time it is taken, with an accuracy of + or − three milliseconds if desired. A second system can control the GPS unit by saving every signal received from the public GPS satellite system to a database, with a time stamp. Finally, a third system can be used to control an inclinometer by saving signals from the inclinometer to another database, with a time stamp. The inclinometer data is used to adjust pictures taken on an incline. Data from the camera, GPS database, and inclinometer database can be used to correctly locate each picture on a map and record its latitude, longitude, car speed, direction, altitude, incline on the x-axis, y-axis, and z-axis.

Some aspects of the technology described in the present application provide one or more methods and systems for the data collecting system that can interact with various equipment such as one, a plurality, or all, of the following:
any car;
any digital spherical camera unit that can be attached to a computer;
any computer with an LCD monitor;
any GPS Unit that can be attached to a computer;
a Custom Navigation and Data Collection Software;
a Custom Data Processing Software;
a large computer storage unit (internal or external hard drive);
a street vector database;
a street maps database;
a camera may be attached to the roof of the car using some type of support system that maintains the camera physically stable, without shaking as the car drives along the roads;
a GPS unit that may be mounted as close to the camera as possible, and both the GPS unit and camera can to be connected to the computer inside the car;
a computer may be connected to a monitor mounted to allow the driver to see the monitor at all times;
custom software that can be programmed to receive data from the GPS unit and store the data in a database;
custom software that may receive data from the camera and store it in a large hard drive (in some aspects as much as up to 100 Gb of data per day or more may be collected and stored);
custom software that may access a database of maps used to display on the monitor a map of the current location, using the data read from the GPS, which can, in some aspects, allow the driver to use the custom software as a navigation tool;
software that can display on the monitor the roads or other areas that have been processed and other roads or areas to be processed later, such as, in some aspects, during that day; and

custom Data Processing software that can read the data collected using the camera and, for example, the GPS. In some embodiments, since the camera can take pictures even when the car is stopped, the data processing software can filter the data by discarding any pictures taken when the car was stopped. Then, the software can check each picture and look for the closest GPS fix for the time the picture was taken. Since, in some embodiments, there is in average one GPS fix per second, and three pictures per second, the software can, if desired, utilize the speed, heading, and latitude/longitude data for the two closest GPS fixes to the time the picture was taken and calculate the latitude/longitude for the picture. After doing so for all the pictures, the software can check the latitude and longitude data against an existing street vector database to determine the street with which the picture is associated. At this point the software may also calculate, for example, the closest orthogonal latitude/longitude point to the picture that lies within the street vector. Once every picture has a latitude/longitude pair of values that lie within a street vector, the software can checks to determine, for each point, whether a picture already has been taken for that location in order to whether the point it is to be saved or discarded.

In another aspect, the data processing system can calculate the latitude and longitude of each picture taken with the data collection system, such as, in some aspects of the methods and systems discussed above. This calculation may be accomplished by working with a dead-reckoning algorithm based on the time stamps for the pictures, GPS fixes, and inclinometer data.

In yet another aspect, the technology of the present application may allow for post-acquisition processing of images to correspond to map-segment vectors that enable a video-like experience. The aspects of the technology moreover may allow the technology of the present application to implementation of a mapping and drive-through web application.

In still another aspect associated with the technology of the present application, a virtual drive-by system may allow a person with network access to command a virtual car and virtually drive the car through virtual roads with the assistance of one or more maps. While virtually driving, the virtual driver may be provided with a video or near video simulation of a view associated with the drive and, either stopped or at speeds may rotate the view perspective up to 360 degrees to view a panorama picture of the location of the virtual car would be, if it were real. The panorama pictures viewed by the virtual driver represent the view to the virtual driver as if he or she were driving down the same road, and the system may include the ability to turn to the side, and look back while virtually driving through the location.

In another aspect, a geospatial search application may allow the user to do combine multiple delimited areas on a single search by displaying only the entries found in the intersection of such areas. As an additional service of some aspects, once a POI (point of interest) is selected from a result grid, the closest image for that POI can be displayed in a panoramic viewer.

The method and system for the acquisition and display of images provides in some aspects a geo-coded address associated with the image. The image in certain cases is used to provide a 360-degree image or images of the geo-coded address. The geo-coded image may be used in one aspect of the technology of the present application, with the virtual drive-by aspects of the technology. To enhance the use of the geo-coded information and images, the technologies explained herein may integrate or access applications and services, including, one, a plurality, or all of the following:
online mapping software;
street vector database;
image database;
viewer software;
software for accessing, managing, and processing one or more image is a storage facility;
search capabilities associated with mapping software linked to geo-coded address such that images of the searched or identified location may be displayed;
one or more controls to orient a display relating to the image to change, for example, field of views, perspective, and the like;
technologies and software to allow image or frames to be displayed to provide a virtual drive experience using video or near video simulations featuring various controls such as, left, right, forward, reverse, U-turn, speed, and the like.

Various achievable advantages of technologies of the present application can include one, a plurality, or all of the following:
little or no dependency on the frequency at which a GPS unit receives a fix from the public satellite system by, in some aspects, using a dead-reckoning algorithm to calculate the camera position at any time after the picture is taken;
the need to control the camera to take pictures only when a location is determined from a positioning unit is eliminated, allowing a car to move faster and take pictures at a high frequency;
a video-like display of the pictures, giving the user a driving sensation;
an efficient approach to collecting data, since the car is driven at 3.3 frames per second; and
a wide variety of possible uses of the technology exist. For example, persons looking for a house in a given neighborhood virtually can drive by the neighborhood without ever leaving their house; insurance companies virtually can check the state of a remote property prior to an accident to help complete a claim; and architecture students virtually can visit cities and virtually look at their buildings without traveling to the location at issue.

There are other aspects and advantages of the invention and/or the preferred embodiments. They will become apparent to those skilled in the art as this specification proceeds. In this regard, it is to be understood that not all such aspects or advantages need be achieved to fall within the scope of the present invention, nor need all issues in the prior art noted above be solved or addressed in order to fall within the scope of the present invention.

### BRIEF DESCRIPTION OF THE DRAWINGS

FIG. 1 is a flowchart illustrating exemplary operational steps associated with an embodiment of the technology of the present application;

FIG. 2 is a functional block diagram of an exemplary system associated with an embodiment of the technology of the present application;

FIG. 3 is a functional block diagram of an exemplary image gathering subsystem of FIG. 2;

FIG. 4 is a functional block diagram of an exemplary image locating subsystem of FIG. 2;

FIG. 5 is a flowchart illustrating exemplary operational steps associated with an embodiment of the technology of the present application to associate an image with a location;

FIG. 6 is a functional illustration of image manipulation to correct for different angular orientations between taking and viewing images;

FIG. 7 is a flowchart illustrating exemplary operational steps associated with adjusting images for the angular orientation identified in FIG. 6;

FIG. 8 is an exemplary display of the images associated with a location comprising multiple display portions;

FIG. 9 is a flowchart illustrating exemplary operational steps associated with fetching images of a particular location of an embodiment of the technology of the present application;

FIG. 10 is an exemplary display and control for a virtual drive embodiment of the technology of the present application;

FIG. 11 is an exemplary display of virtual advertisements that may be inserted in images and video associate with the technology of the present application;

FIG. 12 is a flowchart illustrating exemplary operational steps associated with displaying video or a series of images rapidly to simulate video down a street in accordance with the technology of the present application;

FIG. 13 is a flowchart illustrating exemplary operational steps associated with searching multiple search fields associated with an embodiment of the technology of the present application; and

FIG. 14 is an exemplary operating environment capable of achieving the functionality indicated herein.

### DETAILED DESCRIPTION

The technology of the present application will now be described with reference to the figures contained herein. While the technology will be explained with reference to methods and systems to provide imagery relating to neighborhoods and the like, one of ordinary skill in the art will now recognize that other applications are possible including, for example, remote scouting, hazardous environment inspection, walking path presentation, and the like. Moreover, the technology of the present application also will be described with reference to particular exemplary embodiments. The word “exemplary” is used herein to mean “serving as an example, instance, or illustration.”Any embodiment described herein as “exemplary” is not necessarily to be construed as preferred or advantageous over other embodiments. All embodiments described should be considered exemplary unless specifically identified to the contrary.

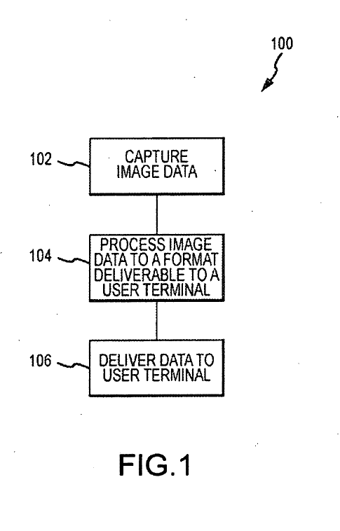

Referring first to FIG. 1, an exemplary process 100 illustrating exemplary operational steps for providing panoramic imagery using technology of the present application to a user. As shown process 100 comprises as an initial matter, capturing the image data, step 102. Next, the image data is processed into a format deliverable to a user terminal, step 104. Finally, the data is delivered to the user terminal, step 106. Typically, the images provided for display at the user terminal are based on a request from a user. Each of these exemplary steps will be explained in more detail below.

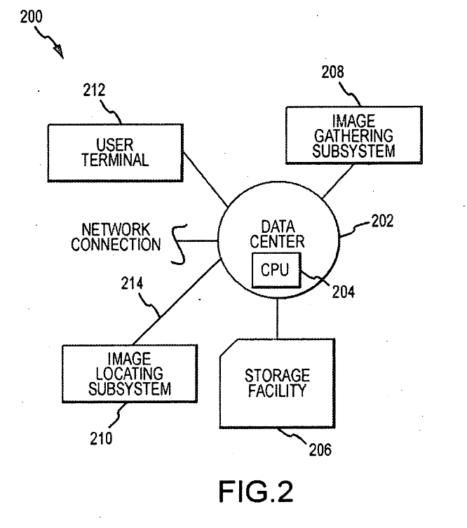

Referring now to FIG. 2, an exemplary system 200 using the technology of the present application to store, locate, and provide panoramic or other imagery to a user is provided. System 200 is illustrated using functional block diagrams. As can be appreciated, more, less, and other functional diagrams may be used to describe system 200. System 200 includes a data center 202. Data center 202 may include one or more processor, server, or the like. Data center 202 may in some instances be referred to as a network operation center (NOC), communication hub, or the like. Data center 202 includes one or more processors 204 co-located or remotely located to each other to provide the computing functionality to process inputs, data, or the like to provide operation of the technology of the present application. Data center 202 may incorporate or be connected to a storage facility 206. Storage facility 206 may be any conventional volatile or non-volatile memory on a suitable storage media. Because storage facility 206 may be required to store numerous images, the location (or generated location) of the images, information regarding strings or vectors of related images, storage facility is may be multiple, networked, mass storage or high density storage drives. Storage facility 206 also may store the various code modules necessary to perform the functional operations illustrated by the exemplary operational steps described herein. The functions may be performed by processor 204 or processors 204 associated with data center 202. As mentioned, storage facility 206 may be one or more storage facilities. The storage or storage facilities may integrated or separate from data center 202. Storage facility 206 also may store images gathered from the image gathering subsystem 208. Storage facility 206 also may store the location information gathered from image locating subsystem 210. Storing the information gathered by imaging gathering subsystem 208 and image locating subsystem 210 allows data center 202 to generate an actual location for each image and associated a plurality of images with a string or vector of information. Alternatively, processors associated with the imaging gathering subsystem 208 and the image locating subsystem 210 may associate the images with generated or measured locations that are stored in storage facility 206. In operation, a user of user terminal 212 would request images from data center 202 based on a location format, such as, for example, street address, historical site name, landmarks, latitude and longitude, or the like. Data center 202 would fetch the images based on the location format from storage facility 206 and transmit the images, as will be explained further below, to user terminal 212 for display to the user. Static images stored in storage facility may be referenced by a pointer and retrieved using a conventional look-up table retrieval system. For example, 1600 Pennsylvania Avenue, Washington, D.C. may be used as a pointer to an image of such a location stored in storage facility 206. To provide a video or near video simulation, as explained further below, images along a particular street may be strung or vectored such that they are associated with each other. This allows data center 202 to stream or batch load a video or near video simulation showing, for example, the presidential walk from Congress to the White House down Pennsylvania Avenue in a video or near video format instead of today's choppy manual, frame by frame method.

The various components identified above may be integrated into a single unit or separate as shown. Moreover, certain portions of system 200 may be combined and other portions of system 200 broken into more functional components.

As shown, data center 202, storage facility 206, image gathering subsystem 208, image locating subsystem 210, and user terminal 212 are connected by communication link 214. Communication link 214 is sometimes referred to as a data link. Communication links 214 may comprise any of a number of protocols such as, for example, a bus, ribbon cable, coaxial cable, optical networks, a LAN, a WAN, a WLAN, a WWAN, an Ethernet, the Internet, WiFi, WiMax, Cellular or the like as a matter of design choice. Moreover, each connection 214 may be the same or different as a matter of design choice. For example, data center 202 may be connected to user terminal 212 using the Internet for communication link 214 while data center 202 is connected to storage facility 206 using a ribbon cable or PCI bus for communication link 214, for example.

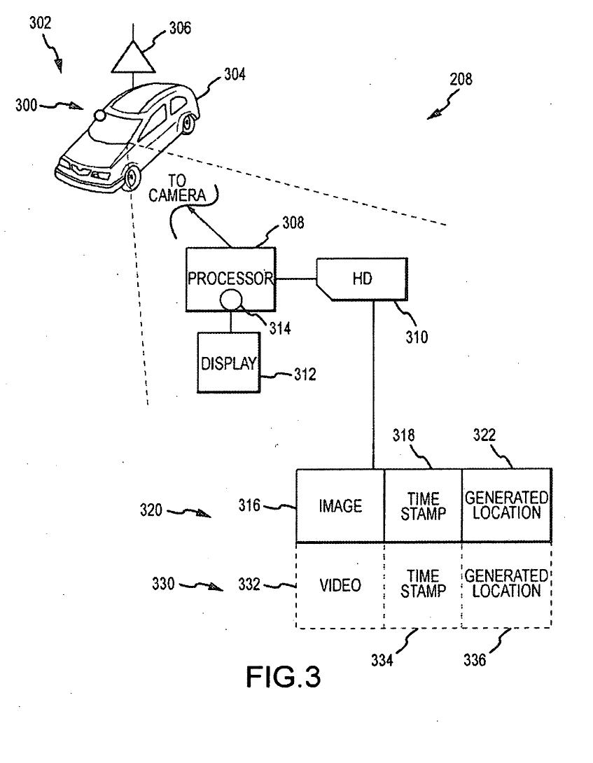

Referring now to FIG. 3, image gathering subsystem 208 is shown in more detail. Image gathering subsystem is shown in functional block diagrams. The functions associated with each block may be combined or separated into additional functional blocks without departing from the spirit and scope of the technology of the present application. Subsystem 208 includes an image acquisition unit 302. Image acquisition unit 302 includes a vehicle 304 having one or more mounted cameras 306 on or in the vehicle. The cameras 306 would be arranged to take simultaneous pictures or video as vehicle 304 travels. Although the description of the technology of the present invention provides for image and video gathering and display, one of ordinary skill in the art will recognize on reading the disclosure that it would be possible to append audio narration to the image or video. Thus, for example, a virtual audio/video tour of an area may be provided. Such a tour may be, for example, associated with a virtual tour of the historic or famous landmarks of London, a narration of a residential district by a real estate agent, or the like. While shown as a conventional automobile, vehicle 304 may be any vehicle, such as, for example, a car, a motorcycle; a truck, a train, a boat, an airplane, a helicopter, robot, person, or the like. As explained herein, vehicle 304 and cameras 306 are described as acquiring imagery of populated areas, hence a car is a logical choice. However, less populous or industrial areas may require alternative image gathering vehicles, such as a boat or off-road vehicle. Camera or cameras 306 should be designed to provide panoramic imagery or a series of linked images that may be processed to provide a panoramic view. Should audio be provided, the audio may be simultaneously recorded and tied to the imagery or video. Alternatively, audio may be added subsequent to the imagery or video generation.

One satisfactory camera 306 is a roof mounted LADYBUG®2 camera available from Point Grey Research, Inc. However, a series of coordinated cameras or other spherical image cameras are well suited for the technology of the present application. Currently, the camera is mounted to the roof of vehicle 304 to provide an unobstructed vertical and near or full 360 degree field of view. Other mountings are possible, but may provide restricted views or require multiple cameras to provide a full 360 degree operation.

As will be explained further below, vehicle 304 or camera 306 may be fitted to provide inclination information to processor 308. The inclination information may be provided by, for example, an inclinometer 300 or the like.

Camera 306 would take pictures as vehicle 304 travels. The pictures would be downloaded to a processor 308 and saved on to a storage facility 310, which may be a large capacity hard drive associated with processor 308 or a separate storage facility. A display 312 may be provided so the operator or passenger of vehicle 304 may observe operation of the camera. Processor 308 may be any conventional computer, server, or processor such as, for example, a laptop computer, a handheld computer, a server, or the like is possible. Ideally, processor 308 (as well as processor 204) will have a graphics accelerator to facilitate the image processing, such as are commonly available from NVidia, ATI, and the like.

Processor 308 has a clock 314. Clock 314 will be synchronized with a clock associated with image locating subsystem 210 as will be further explained below. Each image is uniquely identified with a time stamp. Thus, each image 316 stored in storage facility 310 would be associated with a time stamp 318 and stored to an image data cell 320 for the particular location image. Data cell 320 may have additional information regarding the image as well, including, for example, the inclination of the camera or vehicle during generation of the image. Data cell 320 may link successive images to allow for stings or vectors of images to be played in a video or near video simulation as explained below. Moreover, as will be explained further below, video may be taken as well using one or more video cameras a camera 306. Video would similarly be stored in a data cell 330 as shown in phantom with, for example, a video 332, a time stamp 334, and generated location 336. Video cell 332 is stored and linked frame by frame.

Images should be taken as fast as reasonably possible to provide video or near video like quality to any associated image stream. Currently, image gathering subsystem 208 takes and saves approximately 4 to 6 images a second. However a slower image rate is possible, although it may introduce some of the choppy effects of current technologies as the image rate is slowed down. Depending on the final application, however, video or near video imaging may not be necessary allowing for slower imaging rates.

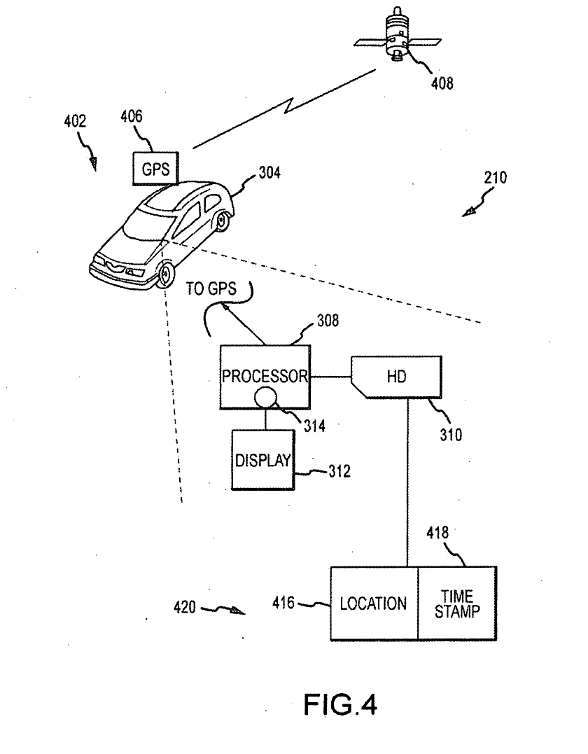

Referring to FIG. 4, image locating subsystem 210 will be described in more detail. Image locating subsystem 210 comprises a location acquisition unit 402. Location acquisition unit 402 includes vehicle 304 and a positioning unit 406. Positioning unit 406 may be a satellite based positioning unit that receives signals from one or more satellites 408. One common satellite positioning system is the Global Positioning System (GPS—Originally titled NAVSTAR GPS when developed by the military) and uses GPS to determine its position. One of ordinary skill in the art will now recognize on reading the present, application that the technology of the present application may incorporate any positioning systems including other satellite positioning systems (SPS), such as, for example, other Global Navigation Satellite Systems (GNSS), Galileo positioning system (Europe), Glonass (Russian), a combination thereof, and the like. Alternatively, positioning unit 406 may incorporate terrestrial based positioning technologies and/or hybrid terrestrial and satellite systems or other positioning technologies.

Positioning unit 406 downloads information to processor 308 concerning the location of location acquisition unit. Clock 314 of processor 308 is synchronized with the positioning unit 406 to provide a location and time stamp associated with each position determination. The location and time stamp would be stored in storage facility 310 as a data cell 420 having a location 416 field and a time stamp field 418. Notice, while described using the same processor, clock, storage facility, and the like, image location subsystem 210 may use different processors, storage facilities, clocks, and the like. Clock 314 (or a separate clock) may be synchronized with the satellite clock should position determination be provided by the GPS system as the GPS clock is highly accurate. In operation, GPS unit 406 should be mounted as close as possible to camera or cameras 306 to provide as precise location information for each image as possible.

As can be appreciated, many more images are taken and stored than locations are taken and stored. In certain instances, the image time stamp and the location time stamp will be identical or sufficiently identical to use the determined location from the positioning unit 406 as the actual location for the image. However, in many cases, the image will not be directly associated with a location from positioning unit 406. In these cases, the actual position of the image/location acquisition unit can be calculated using a simple vector algorithm based on the direction of the vehicle, the speed of the vehicle, and the time difference from the previous location. Adjustment also would be factored based on vertical or altitude changes indicated by the inclinometer. Another conventional algorithm may identify a vector between two successive positioning unit determined locations and generate the location based on the distance traveled between successive images between the two points. These styles of tracking location are well known in the art and are conventionally known as a dead reckoning method of determining location between position determinations. As can be appreciated, vehicle 304 should be driven at a constant velocity if possible. Processor 308 may sense vehicle velocity to better determine actual position. Vehicle velocity and/or speed and direction, may be stored in storage facility 310 for later calculation and addition of generated location 322 to data cell 320.

As can be appreciated, data cells 320 and 420 associated with the image and location information may be transferred from the local memory 310 (and another memory if a separate location memory is provided) to data center storage facility 206. As transferring the data from one memory location to another memory location is common in the industry, the specifics of the transfers are not described herein. Moreover, the data manipulation may be, performed by processor 204, processor 308, a combination or other processors with connections to any of the storage facilities. Thus, the functionality as described in the some of the exemplary operational steps herein are treated the equipment homogenously for convenience. Image data cells 320 taken along a section of road, for example, a block of images along fifth avenue New York, N.Y., may be linked as a vector or string of information. Linking the block facilitates the image display in a virtual tour of the area as explained further below. The string or vector of image information or video information may be tied to a particular road, for example the 92nd block along Park Avenue images may be linked.

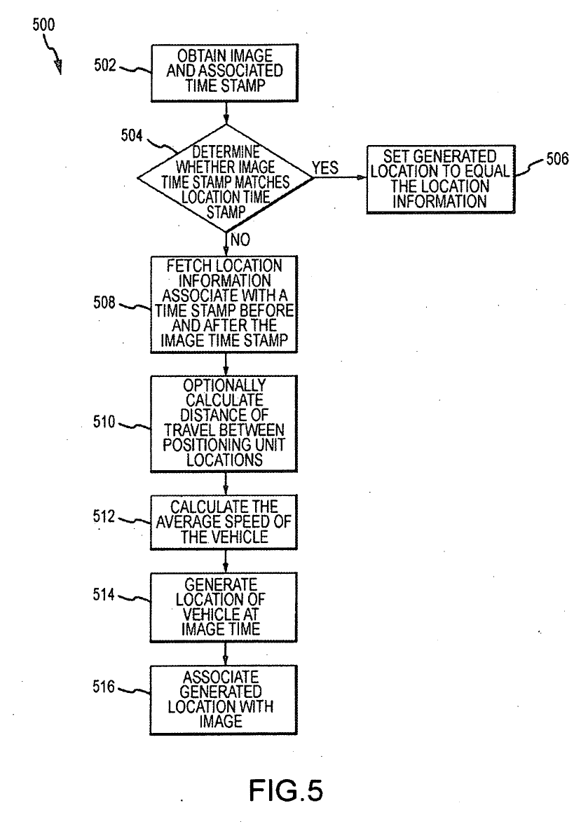

Referring now to FIG. 5, a flowchart 500 illustrating exemplary operational steps associated with associating each image with a generated location is provided. First, an acquired image and its associated time stamp is obtained or identified, step 502. Next, it is determined whether the image time stamp matches any time stamps associated with location information, step 504. If the image time stamp is equal to (or sufficiently close to) the time stamp of the location information, the image generated location is set to equal the location information, 506. If the image time stamp is not equal to (or sufficiently close to) the time stamp of any location information, the process continues by fetching the location information associated with a location time stamp earlier in time than the image time stamp (i.e., before) and the location information associated with a location time stamp later in time than the image time stamp (i.e., after), step 508. Optionally, a distance of travel between the two locations is calculated using conventional techniques, step 510. The average speed of the vehicle is calculated using conventional techniques, step 512. The average speed of the vehicle can be determined between the two location determinations, but ideally the average speed of the vehicle would be determined between the location time and the image time. The position of the vehicle is generated by determining the distance vehicle traveled in the time between the location and the image, step 514. The generated location is appended to the image, step 516. Optionally, the location may be converted between various formats.

Alternatively, only the average velocity of the vehicle and the location associated with the before time stamp is necessary for generating the location of the vehicle at the image time. Also, instead of fetching the immediately proceeding location determination, the system may chose between fetching the immediately proceeding location determination from the positioning unit or, if available, the generated location of the immediately proceeding image.

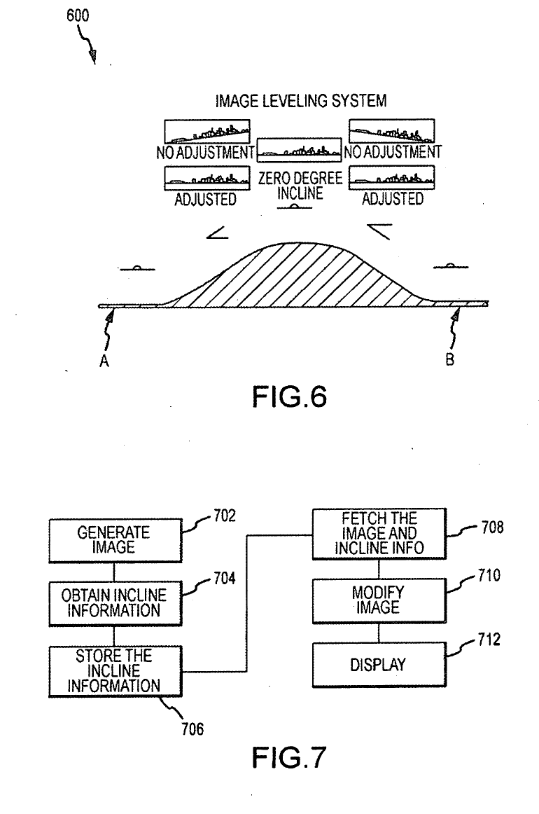

Image acquisition unit 302 includes a vehicle 304 and a vehicle mounted camera 306 (or cameras). As can be appreciated, the camera takes images parallel to the surface structure as shown in FIG. 6. FIG. 6 shows a sampling of a terrain 600 having a variable slope from a point A to a point B. The terrain is exemplary, but varies from flat (or a zero degree angle) to an incline of about 45 degrees to flat, to an incline of about −45 degrees, and back to flat. Providing the images directly to a user terminal for display would result in imaging going from a horizontal view, to an angled view, back to horizontal, angled and finally horizontal again as shown by the top images. It is possible to adjust the images to remove the “tilt” to provide the image as oriented by the viewer as shown by the bottom images.

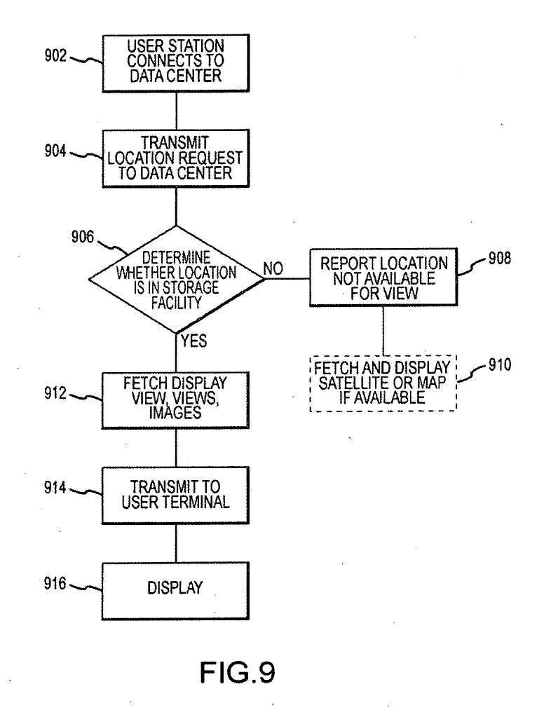

FIG. 7 shows a flowchart 700 illustrating exemplary operational steps to adjust the image to remove title. Initially, an image of a location is generated, step 702. Next, the incline information for the generated image is obtained, step 704. The incline information could be for example, the pitch (x-axis), roll (y-axis), and yaw (z-axis) associated with the car from a horizontal. The pitch, roll, and yaw information for the image is stored, step 706. When a user requests the image, see FIG. 9 described herein, the image is fetched along with the pitch, roll, and yaw information, step 708. Based on the pitch, roll, and yaw, the image is modified to display on the horizontal of the user terminal, step 710. The modified image is displayed to the user, step 712. The adjusted image may be displayed or the unadjusted image may be displayed as a matter of user preference.

Based on the above, images would be stored in a storage facility, such as storage facility 206 as an image, incline information, and a generated location. The time associated with each image may be discarded after adjustment and location or retained as desired. Moreover the locations and times of the positioning unit may be discarded or retained as desired.

Once the location of a particular image is established and stored, the data center 202 may access external or internal applications capable of providing additional images or different images of the area as static or video images. Such images may be captured from satellite based applications, such as, for example, images available from earth.goolgle.com or the like.

While the above has been generally described using a panoramic or spherical view camera, it would be possible to similarly provide video recordings using video cameras. As video is continuous, the locating of particular segments of the video may be accomplished in much the same way as locating particular images. In this case, the video would be time stamped at regular intervals or continuously. The location of any particular portion of video could be accomplished on a frame by frame basis or based on some predetermined time segments, such as, for example, locating a frame every ¼ of a second. The camera taking “still” panoramic or spherical images at a rapid rate, such as about 1 image every quarter of a second or so, allows for reproducing a stream of still images in such a manner to provide video or near video simulation as will be further explained below. While it is probably not required, as explained above, video may be used as well.

To obtain video, for example, vehicle 304 may be mounted with front, left, rear, side, and vertically facing video cameras for the plurality of cameras 306. As mentioned, the video can be taken and stored in data cells having location information relating to particular frames. Alternatively, as video and imagery is taken at substantially the same time, the frame of the video may be linked to a particular image as the image is taken. Thus, for example video stream 10, frame 90210 may be associated with image XYZ as they were taken at the same or at least substantially the same time. The image, and hence the video frame, would subsequently be linked to a location as described herein.

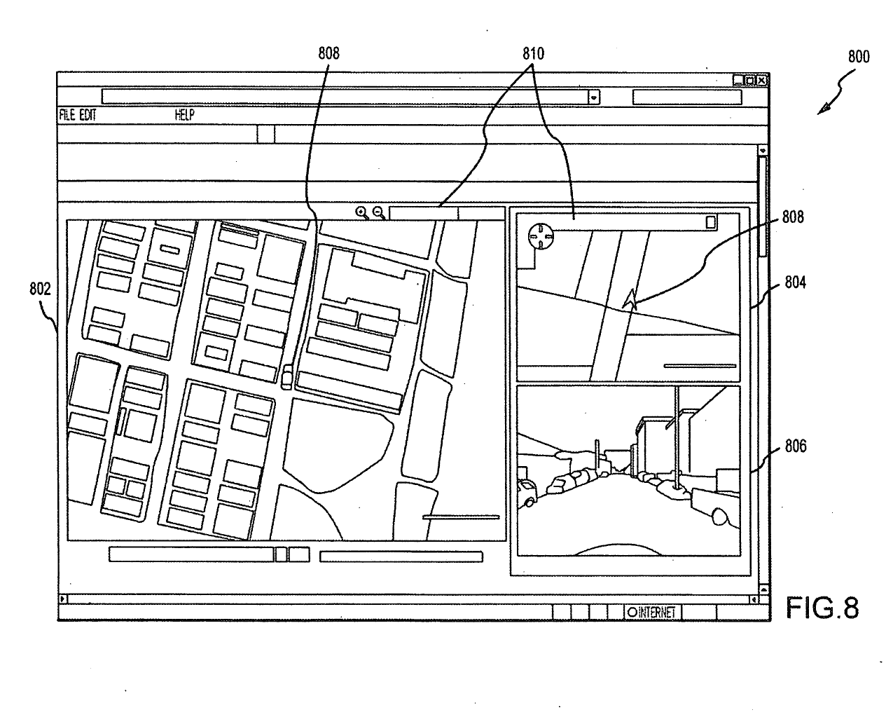

The images cell 320 and/or video cell 330 may be associated with a geo-coded location or generated location 322/336. The geo-coded location would correspond to map information. Thus, street location 1600 Pennsylvania Avenue, Washington, D.C., which can be accessed from map applications, which may be available over the network or integrated into data center 202. Some exemplary maps as are available include maps from Mapquest, Microsoft virtual earth, Google Earth, Google Map, or the like may be displayed at substantially the same time as a visual image of the location. Additionally, other images, such as satellite images also available from Microsoft, GeoEye, Google Earth, and the like, of the location may be obtained from similar. FIG. 8 shows a display 800 of a location 312 Ocean Drive, Miami Beach, Fla. The display may be arranged in one or more ways having a single window, as shown, with three individually running images or using three separate windows to provide the three images. Moreover, more or less images may be substantially provided. In this example, the satellite image 802 is provided in the large left portion of the display 800, a map 804 is provided in upper right portion of the display 800, and a view 806 from image cell 320 or video cell 330 is provided in the lower right portion of the display 800. As the image 320 is captured by a plurality of cameras or a single camera to provide a spherical or panoramic view, a control, such as a mouse, trackball, keyboard, voice interface, light pen, or the like may be used in a conventional manner to alter the view to any of 360 degrees to provide alternative ground views from where the camera 306 took the picture. To ensure accuracy, the location requested may be tied to county plot information if available. Thus, a request for 312 Ocean Drive, Miami Beach, Fla., may update the displays and orient the view 806 to display the requested location.

Each view may be controlled using a zoom in or zoom out function. Once the images are displayed, the satellite image 802 or map 804 may be clicked to select new locations. Icons 808 show the viewer location for view 806 showing a “street level” view for the location. Additionally, as shown by control bars 810, each display portion may be altered between one or more alternative views if available. Such as, for example, map 804 may be converted to a hybrid or bird's eye display as desired. Also, any portion of the display may be provided as a full screen display.

Moreover, while shown as mounted to a vehicle, camera or cameras 306 may be handheld or robot controlled such that the images are from sidewalks, airways, balconies, platforms, observations decks, and the like. Mounting the camera on a robot or the like may be particularly useful to obtain virtual mapping of dangerous areas or the like.

Referring now to FIG. 9, a flowchart 900 illustrating exemplary operational steps for displaying display 800 to a user at the user terminal 212 is provided. In operation, the user terminal 212 would establish a connection to data center 202, step 902. The connection may be an established/always on connection or an intermittent connection. It is envisioned that the user terminal 212 and data center 202 would be connected via the Internet to allow access to information via any internet enabled device. Other connection protocols as identified above are possible. Once the connection is established, the user terminal 212 transmits a requested location to data center 202 via the connection, step 904. The location request may take any appropriate form, such as, for example, a street address, a latitude/longitude/altitude, a historic site name, a landmark site name, or the like. Data center would determine whether the requested location has any associated image cells 320 or video cells 330, step 906. If an associated image cell or video cell is not available, a message that the location is not available may be delivered to the user terminal, step 908. Optionally, instead of simply indicating the location is not available, view 806 may be left blank and/or updated with a not available indication while data center 202 fetches and transmits satellite and map information for satellite image 802 and map 804 for display 800, step 910. If images are available, data center 202 fetches images 316, videos 332, or a combination thereof as well as any other associated views for display 800, step 912. The images, videos, satellite, map and the like are transmitted to user terminal 212, step 914, and displayed, step 916. For reference, user terminal may be a thin or thick client as a matter of design choice. The transmission of the information may be a batch transmission, a stream transmission, a combination thereof, or the like. The user at user terminal 212 may operate controls to adjust the picture in view 806 to display any available field of view. To reduce transmission time, user terminal 212 may be loaded with a viewer to allow for manipulation of panoramic images. Alternatively, a live bidirectional streaming connection may be provided to allow controls signals to be transmitted to data center 202. Data center would adjust the image and stream it back to be viewed in the display of user terminal 212.

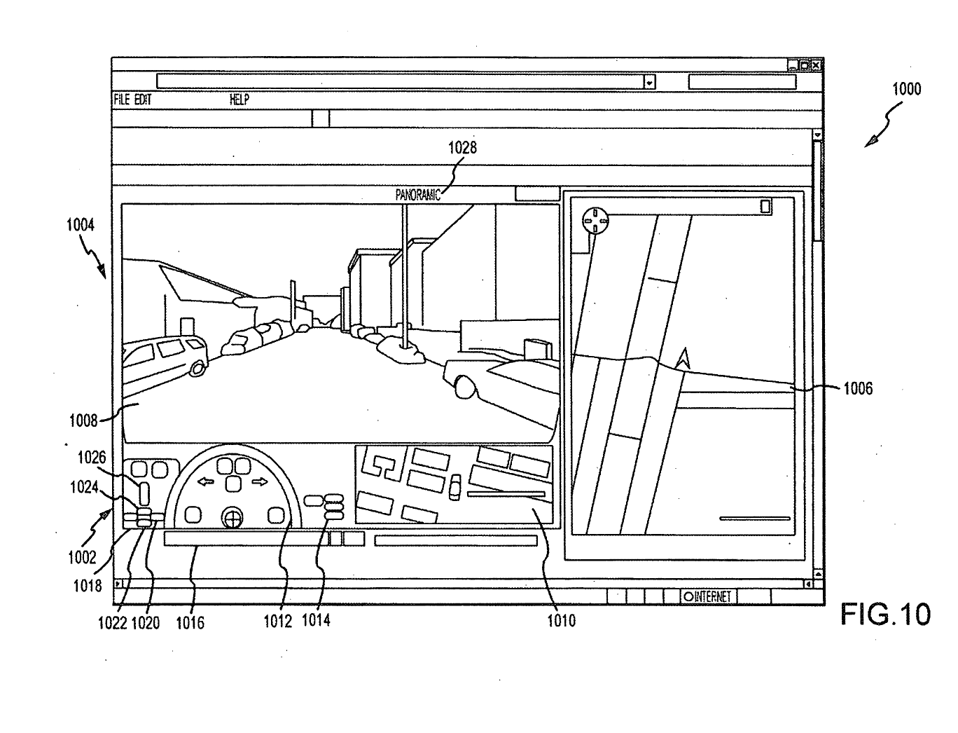

While the static display provided above is useful in its own accord and provides higher location resolution than currently available, the rapid image or video provides a means for allowing a virtual driving tour of a location. A possible control panel 1000 to provide a virtual driving tour of a location is shown in an exemplary embodiment in FIG. 10. Control panel 1000 includes control icons 1002 and display 1004. Display 1004 is provided with three views in this example, a map view 1006 and a video view 1008, and a satellite view 1010. However, other views, such as a bird's eye view may be displayed or less views, including only one view, may be displayed as well. Control icons 1002 include a steering wheel 1012 to “virtually drive” the car or image acquisition unit 302 or vehicle 304. The steering wheel 1012 provides a mechanism to turn left or right, such as when an intersection is reached. A speed control icon 1014 provides speed of video options, such as forward, forward slow, forward fast, reverse, reverse slow, reverse fast or the like. Control icons 1002 on control panel 1000 may be switch from the clickable control panel as shown to a remote keyboard similar to a game platform or the like as is conventional in the art. Moreover, the controls may be simple left, right, forward, back controls as a matter of design choice. While described as video, the display may in fact the individual images presented in succession to provide a video or a near video simulation. As shown, control panel 1000 may include a location indicator 1016 that would update as known locations are passed. Known locations may include positioning unit locations, generated locations, county plot addresses, a combination thereof, or the like.

Control panel 1000 may include view options, such as, a left view control 1018, a right view control 1020, a rear view control 1022, a front view control 1024, and a vertical view control 1026. These views would simulate looking out the left, right, rear, front, and sunroof windows of a vehicle. In these alternative views, the vehicle may be locked to travel in a particular direction, or controlled to turn on a predefined route. Controlling the virtual drive on a predefined route may be similar to using a macro control to turn left or right at particular intersections or the like. If a predefined drive is provided, it may be possible to add audio narration to the video or video simulation to describe the view/image being shown. The virtual drive may be toggled between the video and panoramic view by a toggle control 1028. Toggling to the panoramic view would provide the panoramic view as indicated above.

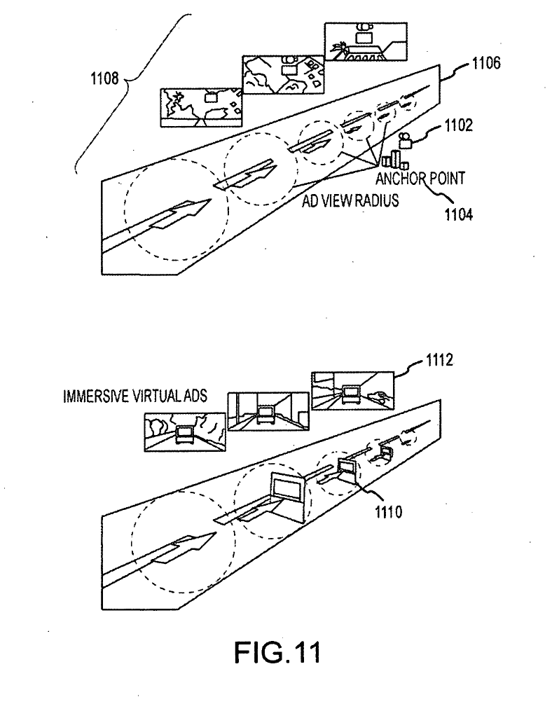

In one aspect of the virtual drive, advertisement may be inserted into the virtual drive by populating the field with virtual billboards, placing product on features, such as any parked cars may be converted to various Honda cars, etc. Virtual adds would be inserted into the video or image data stream using conventional insertion technologies. Additionally, the control panel 1000 may support pop up or banner ads as desired. Video also may be superimposed in the control panel to provide a moving advertisement. For example, a bus in front of the virtual car may move in conjunction with the virtual car. Exemplary virtual ads are shown in FIG. 11. A static billboard 1102 is shown on a building 1104. As the virtual vehicle drives down road 1106, the billboard 1102 will be seen in successive views, such as represented by stills 1108. Additionally, an ad 1110 may be placed on a bus 1112 traveling in front of the virtual vehicle to provide ads.

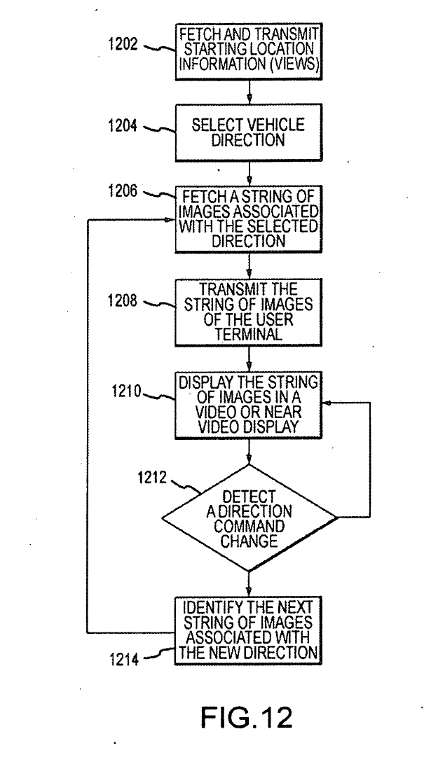

Referring now to FIG. 12, a flowchart 1200 illustrating operational steps of a virtual drive will be provided. First, the user selects a starting point and the data center fetches and transmits the starting point information as described above in FIG. 9 and the associated text, step 1202. The user selects a vehicle direction, step 1204. The data center fetches a string of images associated with the selected direct, step 1206. The string of images are transmitted to user terminal 212, step 1208, and displayed successively, step 1210, to provide a video or near video simulation. For example, the user may select a direct command to move down the available street. The system would then monitor for a direction command change (i.e., left turn, right turn, U-turn, stop, or the like), step 1212. Based on the new command, data center would identify the next string of images available for the selected command based on current location, step 1214. Control would revert to step 1206. The next string of images may be at the next available turn (right or left), immediate (U-turn or stop) or the like. As described, images are associated with street vectors. A street vector provides information about the portion of the street that it represents. Each vector contains a starting point (such as, for example, latitude/longitude, street address, etc.), an end point (which would typically be in the same format as the starting point), and a street name. During data processing, for each image processed, the closest street vector for the image location is identified and the image is projected on or to the vector. Then the latitude and longitude of this projection is saved with the image. During street navigation, when a request is made for the virtual drive, all images for a given vector are retrieved. When a turn command (left, right, etc.) is detected, the system looks for vectors that are joined or connected with the current vector and determines the specific one of the joined or connected vectors that represents the turn to be taken. If there are more than one vector towards a given general direction, the vector representing the largest turning angle is used.

Moreover, by linking the image to a street vector, newer images may be used to replace older images by associating a new image with the street vector. Older images associated with the same vectors are subsequently deleted, archived or the like as a matter of choice. Retaining older images may be useful to show how a location has changed over time to determine, among other things, market trends or the like.

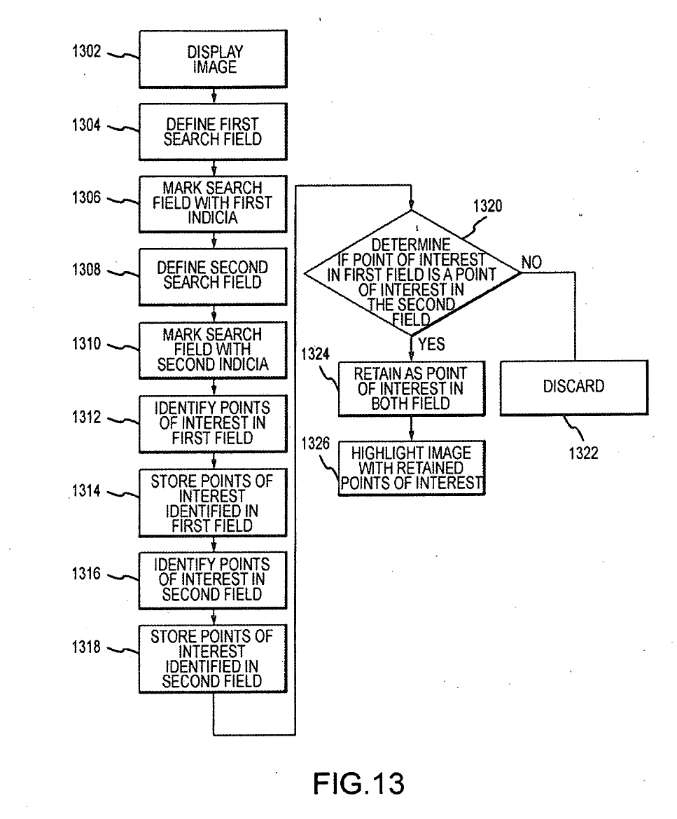

Data center 202 may have access to a directory, an address book via the network or storage facility 206. One such on-line address book include, for example, Dex-Online®, available over the Internet from Dex Media, Inc. Using the online or available directory, a user at user terminal viewing a location, such as, 312 Ocean Drive, Miami Beach, Fla. as shown in figure, may search for businesses using key words, such as, restaurant. Data center would fetch all locations indicated by the address book identified as restaurants in the displayed location and populate the satellite image or map with the information. For example, if the display is zoomed out to a five mile radius from the displayed location, and the user requests information for “DOMINOS PIZZA”, the data center would identity all dominos pizzas within the five mile radius and highlight the locations on the satellite or map image. Alternatively to a radius from a central point, the user may be able to define geographic boundaries for a search and/or draw a search area for the search. The search area may be a polygon, elliptical, or random shape. Its possible combine multiple geometries into a search as well, such as, for example, a rectangular and elliptical field to identify the points of interest in the intersecting field. Referring to FIG. 13, a flowchart 1300 illustrating operational of a multiple search geometry search is provided. First, an image is displayed, step 1302. A first search field is defined, such as a radius about a position, step 1304. The first search field is marked using a first indicia, step 1306. The first indicia may be painting the background with a first color or the like. Next a second search field is defined, such as a rectangle, step 1308. The second search is marked using a second indicia, step 1310. The second indicia may be using a cross-hatch, second color, or the like. Next, all points of interest in the first search field are identified, step 1312, and stored, step 1314, such as in a first list. Next all points of interest in the second search field are identified, step 1316, and stored, step 1318, such as in a second list. Each point of interest in the first list is compared to the points of interest in the second list, step 1320. If it is determined that the point of interest in the first list is not contained in the second list, the point of interest information is discarded, step 1322. If it is determined the point of interest in the first list is in the second list, it is retained as in both search fields, step 1324. As can be appreciated, more than two search fields are possible. The retained points of interest are highlighted in the displayed image, step 1326.

Notice, for non rectangular search fields, a maximum rectangular search field containing the non rectangular search field is further defined. All points of interest in the maximum rectangular search field are identified. Those points of interests not marked with the indicia are discarded as not in the appropriate search field. Notice, the marking steps are optional for certain search fields.

If the user subsequently selects a particular identified location, a route map may be provided using conventional technology. Once a route is provided, the route may be loaded into a drive program to automatically drive the virtual vehicle to the desired location, allowing user to stop and view images as desired. Alternatively, the user may view only portions of the route by highlighting intersections from the route to view the images, and visual imagery of the route can be provided using the technology explained above. Still alternatively, the images for intersections and the like may be automatically displayed once a route is determined.

As the images or video are tied to a location and map information, the ability to update the system is achievable as the next pass down a residential street can replace previous data although the generated locations for the image data cells and video data cell will likely not match. This is possible because the road information for the first pass and subsequent passes remains the same. Moreover, because the images are tied to the road information, the virtual controls may be provided to only allow operations available to the “actual drive.” This inhibits a virtual drive from turning into a private drive, for example, and a turn command will be held in a cache until the virtual video reaches a point where the command can actually be executed.

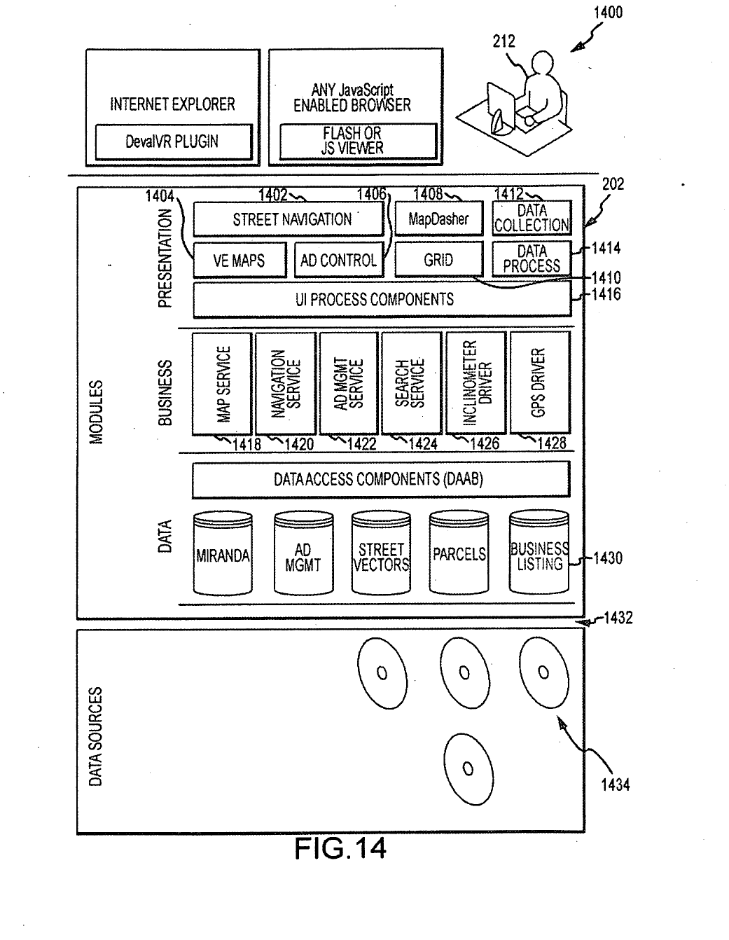

FIG. 14 shows a possible operating environment 1400 for the technology of the present application. The operating environment includes a client or user terminal 212 connected to a data center 202. The user terminal 212 may have browser such as internet explorer and a image video driver such as a Deval VR Plugin. The operating system at user terminal 212 may be enabled to run various scripts such as java, brew, Microsoft, or the like. Data center 202 may include various application modules to perform the various functions described herein include a street navigation module 1402, a map module 1404, an ad module 1406 (which may provide virtual billboards, video inserts, or the like), a point of interest identifier module 1408, a route module 1410, a data collection module 1412, a data processing module 1414, an interface module 1416, a map service module 1418, a navigation service module 1420, an ad management service module 1422, a search service module 1424, an inclinometer module 1426, a positioning unit module 1428, and one or more memory units 1430 (a.k.a. storage facilities). Data center 202 may link via a network to numerous data sources and/or provide a media drive 1432 to accept media 1434 with necessary data to perform the above operations.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The various illustrative logical blocks, modules, and circuits described in connection with the embodiments disclosed herein may be implemented or performed with a general purpose processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by a processor, or in a combination of the two. A software module may reside in Random Access Memory (RAM), flash memory, Read Only Memory (ROM), Electrically Programmable ROM (EPROM), Electrically Erasable Programmable ROM (EEPROM), registers, hard disk, a removable disk, a CD-ROM, or any other form of storage medium known in the art. An exemplary storage medium is coupled to the processor such the processor can read information from, and write information to, the storage medium. In the alternative, the storage medium may be integral to the processor. The processor and the storage medium may reside in an ASIC. In the alternative, the processor and the storage medium may reside as discrete components in a user terminal.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A method of acquiring and associating images with a location to provide a virtual tour of the location, comprising:
taking a plurality of images with an imaging device;
indicating when each of the plurality of images was taken by a first time stamp;
generating a plurality of locations of the imaging device while it is taking the plurality if images;
indicating when each of the plurality of locations is generated by a second time stamp;
calculating a generated location for each of the plurality of images using a time difference between the first time stamp and at least one of the second time stamps and a velocity of the imaging device;
storing each of the plurality of images with the generated location wherein each of the plurality of images are associated with a location.
